(19) United States
(12) Patent Application Publication
(10) Pub. No.: US 2005/0171729 A1
(43) Pub. Date: Aug. 4, 2005

(54) Method and apparatus to view capacity information of bags and testimonial information concerning products

(76) Inventors: Anthony L. Reynolds, Denver, CO (US); Jon C. Nordmark, Highlands Ranch, CO (US)

Correspondence Address: SHERIDAN ROSS PC, 1560 BROADWAY, SUITE 1200, DENVER, CO, 80202, US

(21) Appl. No.: 11/046,557

(22) Filed: Jan. 28, 2005

Related U.S. Application Data
(60) Provisional application No. 60/540,230, filed on Jan. 29, 2004.

(51) Int. Cl. G06F 15/00

(52) U.S. Cl. 702/156

(57) ABSTRACT

An on-line shopping system to provide capacity information for the sales of bags is provided herein. More specifically, a user can select indications of various displayed items and, in response, the system provides an indication as to whether the items would fit within the bag or not, along with an indication of the capacity remaining and the capacity filled in the bag. The system also provides packing lists for items that would fit within the bag and correspond to use of the bag for a particular purpose. While shopping on-line, the user can view testimonial information from others concerning their use of and opinions relating to the same product to assist in making a purchase.

### REFERENCE TO RELATED APPLICATION

The present application claims the benefit of U.S. Provisional Patent Application Ser. No. 60/540,230, entitled “Super Testimonial”, filed Jan. 29, 2004, and is incorporated herein by reference in its entirety.

### FIELD OF THE INVENTION

The present invention relates to an apparatus and method to determine a capacity of a bag in terms of items that would fit within it, select bags matching particular criteria and view testimonial information concerning products while shopping on-line or via catalogs.

### BACKGROUND OF THE INVENTION

When shopping on-line, products for sale must necessarily be represented by pictures, icons, or textual descriptions. For example, a site that sells bags may use digital photographs of the bags so that a customer can see the appearance of the bag. However, sine the customer cannot see the actual bag in-person when shopping on-line, it may be difficult for the customer to visualize or determine how many items or what collection of items will fit within the bag.

Accordingly, a need exists to provide ways to assist a customer in determining a capacity of bags for sale and provide additional information about the bags or other products.

### SUMMARY OF THE INVENTION

A first method and apparatus consistent with the present invention can be used to provide an indication of a capacity of a bag. In the first method and apparatus, a selection of a bag is received, and indications of a plurality of items are displayed, a et of which are to be virtually placed within the bag. A selection of one or more of the items is received, and it is then determined whether the selected one or more items will fit within the bag.

Accordingly, in one aspect of the present invention, a method for providing an indication of a capacity of a bag is provided, and which generally comprises:
receiving a selection of a bag;
displaying indications of a plurality of items;
receiving a selection of a set of the plurality of items; and
determining whether the selected set of said plurality of items will fit within the selected bag and providing an indication of the determination.

A second method and apparatus consistent with the present invention provide of compiling information for a product testimonial. In the second method and apparatus, an electronic form is provided having a plurality of questions concerning use of a product for completion by a user. Testimonial information is received from the user, via the electronic form, relating to the use of the product, and that information is associated with the product. When another user browses on-line for potential purchase of the same product, the testimonial information associated with that product is displayed for it.

Accordingly, in another aspect of the present invention, a method for compiling information for a product testimonial and subsequently utilizing that information to purchase a product is provided, and which generally comprises:
providing an electronic form having a plurality of questions concerning use of a product for completion by a user;
receiving testimonial information from the user, via the electronic form, relating to the questions concerning the use of the product;
associating the information with the product; and
wherein when another user browses on-line for potential purchase of the product, displaying the testimonial information associated with the product.

Another aspect of the present invention relates to identifying an attache or bag suitable for any given laptop computer. More specifically, in one embodiment the invention comprises:
receiving an identification of a particular laptop computer;
determining one or more bags suited for carrying the particular laptop computer; and
displaying an indication of the one more bags.

Another aspect of the present invention relates to a method for providing an indication of a carry-on bag for a particular airline. Thus, in one embodiment, the method comprises:
receiving an identification of a particular airline;
determining one or more carry-on bags approved by the particular airline; and
displaying an indication of the one or more carry-on bags.

### BRIEF DESCRIPTION OF THE DRAWINGS

The accompanying drawings are incorporated in and constitute a part of this specification and, together with the description, explain the advantages and principles of the invention.

FIG. 1 is a diagram of an on-line system for shopping for bags or other products;

FIG. 3 is a flow chart of a main method;

FIG. 4 is a flow chart of a shopping method;

FIG. 5 is a flow chart of a super testimonial method;

FIG. 6 is a diagram of a bag capacity screen;

FIG. 7 is a diagram of the bag capacity screen illustrating use of the bag capacity method;

FIG. 8 is a diagram of a catalog screen;

FIG. 9 is a diagram of a laptop finder screen;

FIG. 10 is a diagram of a carry-on finder screen;

FIG. 11 is a diagram of a screen for entering a super testimonial; and

FIG. 12 is a diagram of a screen illustrating an example of a super testimonial for a particular product.

### DETAILED DESCRIPTION

Embodiments consistent with the present invention provide for an on-line shopping system to provide capacity information for the sale of bags. A user can select various displayed items to be virtually added to a displayed indication of a bag and, in response, the system provides an indication as to whether the items would fit within the bag or not, along with an indication of capacity remaining and the capacity filled in the bag. The system also provides packing lists for items that would fit within the bag and correspond to use of the bag for a particular purpose. While shopping on-line, the user can view testimonial information from others concerning their use of and opinions relating to the same product, possibly along with images of the other customers while using the product.

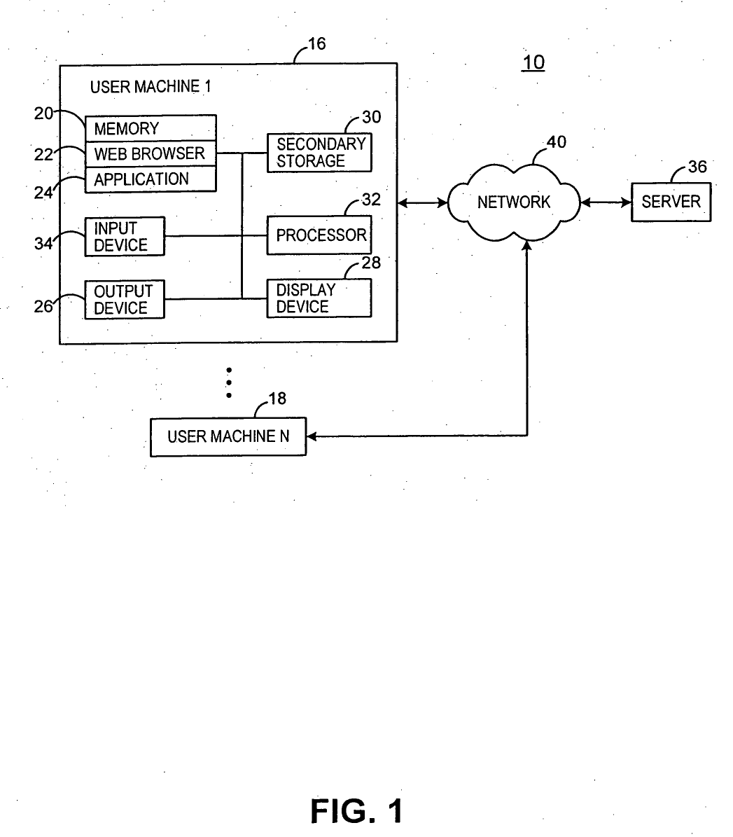

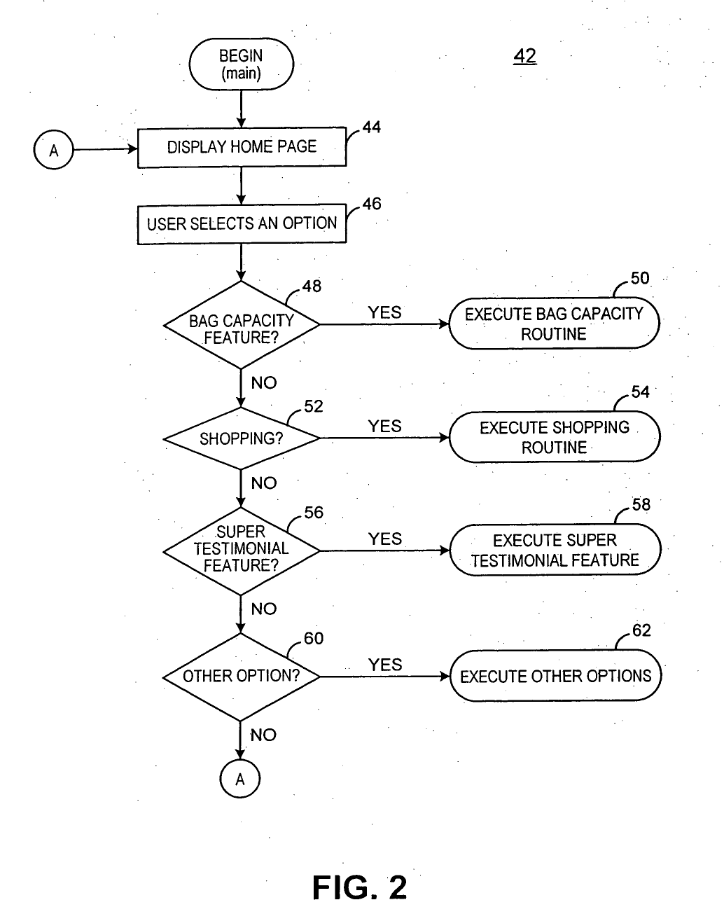

FIG. 1 is a diagram of an on-line system 10 for shopping for bags or other products. User machines 16 and 18 are connected with a network 40, such as the Internet or other network. Users or customers at user machines 16 and 18 interact with a server 36 in order to browse products and perform on-line shopping. Server 36 is connected with network 40 and may be used by user machines 16 and 18 to provide content or other information for on-line shopping. Only two user machines are shown for illustrated purposes only; system 10 may include many user machines and additional or back-up servers.

User machine 16 illustrates typical components of a user machine. User machine 16 typically includes a memory 20, a secondary storage device 30, a processor 32, an input device 34, a display device 28, and an output device 26. Memory 20 may include random access memory (RAM) or similar type of memory, and it may store one or more applications 24, and a web browser 22, for execution by processor 32. Secondary storage device 30 may include a hard disk drive, floppy disk drive, CD-ROM drive, or other types of non-volatile data storage. Processor 32 may execute applications or programs stored in memory 20 or secondary storage 30, or received from the Internet or other network 40. Input device 34 may include any device for entering information into machine 16, such as a microphone, digital camera, video recorder or camcorder, keyboard, cursor-control device, or touch-screen. Display device 28 may include any type of device for presenting visual information such as for example, a computer monitor or flat-screen display. Output device 26 may include any type os device for presenting a hard copy of information such as a printer, and other types of output devices include speakers or any device for providing information in audio form.

Machine 18 can include the same or similar components as machine 16. Both of these machines, and server 36 can interact via network, 40 using any particular protocols such as, for example, Transmission Control Protocol/Internet Protocol (TCP/IP).

Web browser 22 is used to access information for on-line shopping display it in web pages. Examples of web browsers include the Netscape Navigator program and the Microsoft Internet Explorer program. Any web browser or other application capable of retrieving content from a network and displaying pages or screens may be used.

Examples of user machines for interacting with server 36 include personal computers, laptop computers, notebook computers, palm top computers, network computers, or any processor-controlled device capable of executing a web browser or other type of application for interacting the system.

Although machine 16 is depicted with various components, one skilled in the art will appreciate that this machine can contain additional or different components. In addition, although aspects of an implementation consistent with the present invention are described as being stored in memory, one skilled in the art will appreciate that these aspects can also be stored or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling, or software modules configured to control, a computer system, such as machine 16, to perform a particular method.

FIG. 2 is a flow chart of a main method 42. Method 42 can be implemented in, for example, software modules for execution by server 36. In method 42, the system displays a home page to a user (step 44), using web browser 24 in the user's machine. This typically occurs by the user logging onto the Internet or other network and accessing a home web page for shopping or other purposes, using for example conventional network protocols such as that identified above. An example of a home page for product shopping is included in the provisional application identified above.

The system detects whether the user selects a particular option (step 46). Selecting an option can include, for example, the user “clicking on” a particular portion of the screen using a cursor control device, or selecting an option from various displayed menus. If the user selects a bag capacity feature (step 48), the system executes a bag capacity routine (step 50). If the user selects a shopping features (step 52), the system executes a shopping routine (step 54). If the user selects a super testimonial feature (step 56), the system executes a super testimonial routine (step 58). The home page may also include other options, and if a user selects such an option (step 60), the system executes those options (step 62). For example, the home page may include other particular features or links, and the user's browser may include a toolbar with typical functions for web browsing.

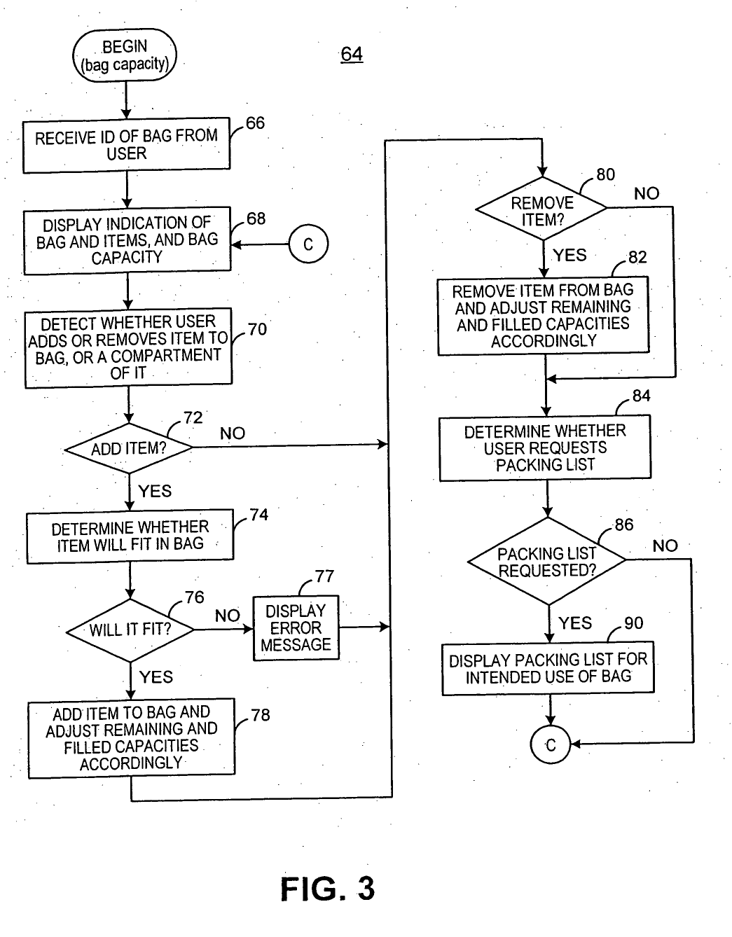

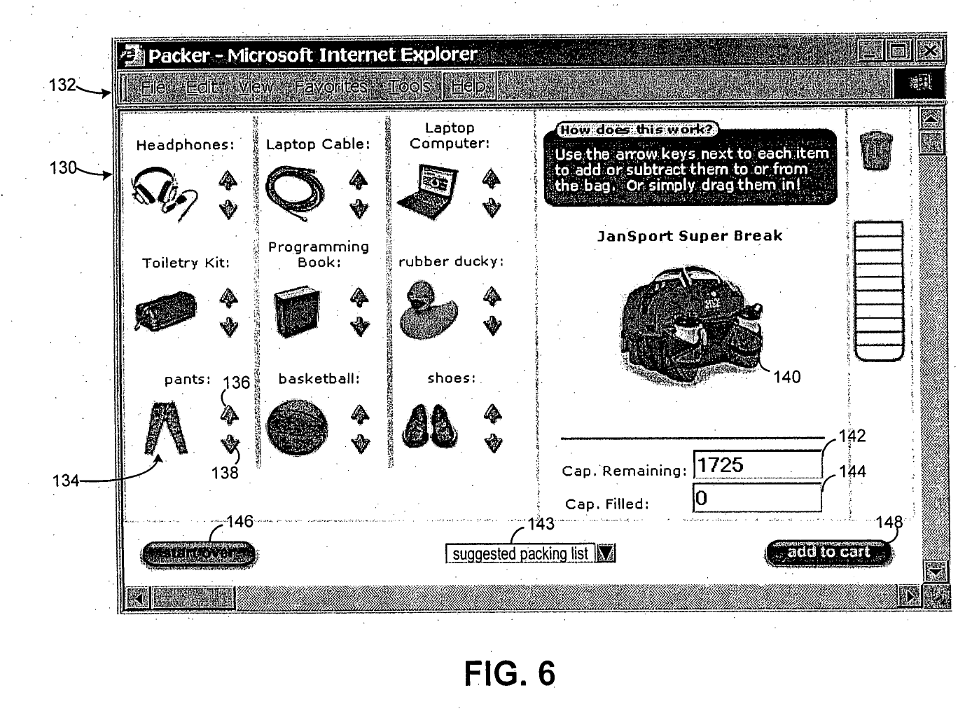

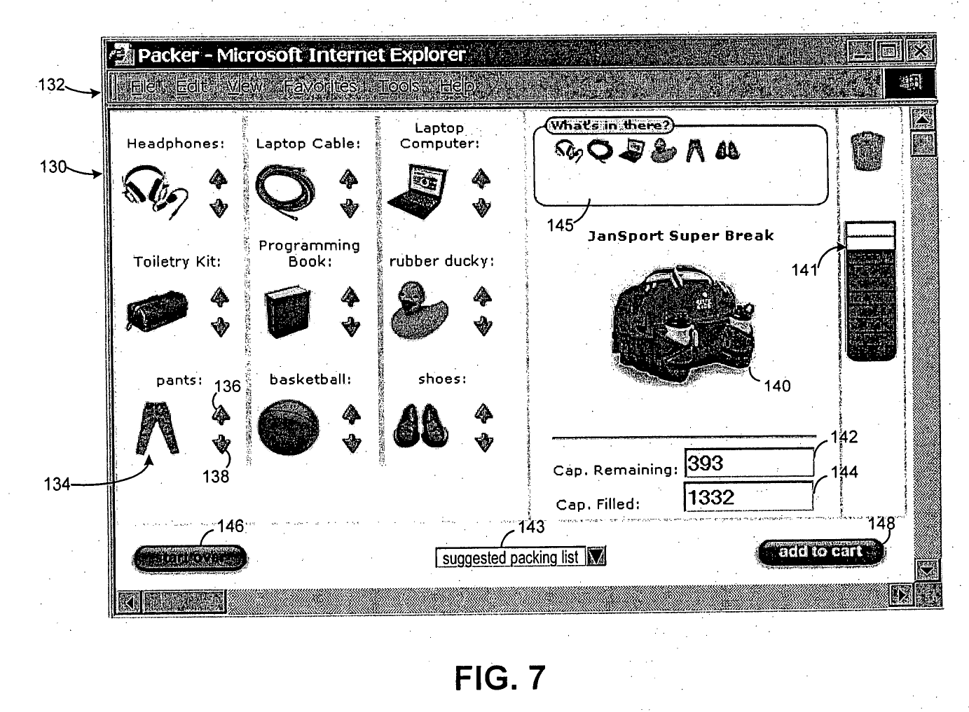

FIG. 3 is a flow chart of a bag capacity method 64 for use in executing the bag capacity routine identified in step 50. Method 64 can be implemented in, for example, software modules for execution by server 36. FIG. 6 is a diagram of a bag capacity screen 132 that can be used in conjunction with method 64, and FIG. 7 is a diagram of the bag capacity screen 132 illustrating use of the bag capacity method, as explained below.

Screen 132 includes a section to identify a particular bag 140 and a section 130 to display particular items to determine whether they will fit within bag 140. A section 142 indicates a capacity remaining of bag 140 and a section 144 indicates a capacity filled, when items are virtually added to or removed from the bag. The user can select items, such as pants 134, by selecting or “clicking on” the up arrow next to each item to add it to bag 140 and be selecting down arrow to remove it from bag 140 and select arrows 138 to virtually remove the pants 134 from bag 140. A section 146, when selected, allows a user to start over the process of determining whether a set of the items will fit within bag 140 by having all added items virtually removed from the bag. A user can select a section 148 to add bag 140 to an on-line shopping cart for purchase.

In method 64, shown in FIG. 3, the system receives identification of a particular bag from the user (step 66). For example, the user may identify a bag within a different screen illustrating many bags for sale, or the user could select the bag from a pull-down menu or other way in screen 132. Upon receiving the identification, the system displays a representation of the bag (step 68), for example bag 140. For example, the system can display a digital image of the bag, an icon representing the bag, text describing the bag, or other ways to identify the bag in screen 132. The system also displays capacity of this bag in section 142 and several items in section 130 for selection. The items identified in section 130 can include a default listing of items or it can include a particular group of items corresponding with the selected bag. As shown, the system can display icons representing the items, or indicate them in other way such as by images or text.

The system can include a database that correlates each bag with its capacity and a default group of items, as illustrated in Table 1. In some instances, a bag may have multiple compartments, and the database can correlate the capacity of each compartment with the corresponding bag. Also, for use in determining whether items will fit within a particular bag or one of its compartments, the system can include a database that correlates items with their volume, shape, and an adjusted volume based upon shape, as illustrated in Table 2. The actual volume of the items is adjusted based upon their shape, as explained below, to take into consideration the shape of the objects to determine whether they will fit within a bag for this particular embodiment.

TABLE 1

| Bag | Capacity | Item Groups |
|---|---|---|
| bag 1 | capacity 1 | item group 1 |
| bag 1, compartment 1 | capacity 1a | item group 1a |
| bag 1, compartment 2 | capacity 1b | item group 1b |
| . | | |
| . | | |
| . | | |
| bag 1, compartment n | capacity 1n | item group 1n |
| bag 2 | capacity 2n | item group 2n |
| . | | |
| . | | |
| . | | |
| bag N | capacity Nn | item group Nn |

TABLE 2

| Item | Actual Volume | Shape | Adjusted Volume |
|---|---|---|---|
| item 1 | volume 1 | shape 1 | adjusted volume 1 |
| item 2 | volume 2 | shape 2 | adjusted volume 2 |
| . | | | |
| . | | | |
| . | | | |
| item N | volume N | shape N | adjusted volume N |

The system detects whether the user ads or removes an item to or from bag 140 or a compartment of it (step 70), such by selecting arrows 136 or 138. If the user adds an item (step 72), the system determines whether the item will fit within bag 140 (step 74). The user may have already previously added other items to bag 140, and the system must therefore determine if the selected set of items, including the newly selected item, will fit within bag 140. If the selected item will fit (step 76), the system “adds” the item to bag 140 and adjusts sections 142 and 144 accordingly for the capacity remaining and filled. It also adds the icon for the item to section 145 and adjusts bar graph 141 accordingly. Screen 132 can also include a bar graph 141 (see FIG. 7), pie chart (not shown) or other visual aid to graphically illustrate capacity remaining and filled with the increasing dark bars indicating capacity filled and empty bars representing capacity remaining. The volume exceeded in the bag may also be illustrated. Screen 132 can also include a section 145 (see FIG. 7) to pictorially represent the set of items selected to be added to bag 140.

Determining whether an item will fit within the bag can make use of an algorithm that considers sizes of the items or, alternatively, both size and shape of the items. For considering sizes of the items, the system can mathematically determine whether a selected item will fit by considering the volumetric size of the item in conjunction with the other items as a cumulative total. In order to take into consideration a shape of an item, the system takes the actual volume of the item and adjusts that volume parameter based upon its shape classification (see Table 2). One embodiment uses, but is not limited to, the following classifications for shape: general; square; rectangular; spherical; and other. With those factors in mind, for an item to fit, the capacity filled plus the selected adjusted item size must be less than or equal to the total bag capacity. The total bag capacity is the capacity remaining when the capacity filled equals zero. This specific embodiment uses cubic inches for the capacity of bags and sizes of items, however as appreciated by one skilled in the art other volumetric scales or measurements may be used.

In order to adjust the capacity remaining and capacity filled of sections 142 and 144, when an item is added or removed from a bag, the system may likewise use a formulaic approach. For adding an item, the new capacity filled equals the previous capacity filled plus the adjusted item size, and the new capacity remaining equals the previous capacity filled minus the adjusted item size. For removing an item, the new capacity filled equals the previous capacity filled minus the adjusted item size, and the new capacity remaining equals the previous capacity filled plus the adjusted item size.

If the selected item will not fit within bag 140 (step 76), the system can display an error message to the user (step 77), such as within a pop-up window or in other ways. If the user had instead elected to remove an item from bag 140 (step 80), the system “removes” the item from bag 140 and adjusts the remaining and filled capacity in sections 142 and 144 accordingly. It also removes the icon for the item to section 145 and adjusts bar graph 141 accordingly.

The system can also include suggested packing lists for bags that correspond with a user's intended purpose for the bag. For example, the user can select from a plurality of suggested packing lists from a pull-down menu 143 indicating several intended uses. An intended use can include a typical use for a bag, for example intended uses for a backpack may include day hiking, overnight hiking, carrying items for school, or other uses. The suggested packing list includes typical items corresponding with the intended use. For example, if the intended use for a backpack is school, then the suggested packing list may include items such as books, notebook, pens, pencils, eraser, umbrella, and other items. As appreciated by one skilled in the art, these examples are provided for illustrative purposes only and many other intended uses and corresponding packing lists are possible. Further, although the bag capacity routine discussed herein is generally described for use in bags and luggage, the same concept can be used for broader applications including but not limited to rooftop carriers, backpacks, vehicle trunk space, etc.

The system can include a database that correlates suggested packing lists with the corresponding intended uses and bags, as illustrated in Table 3.

TABLE 3

| Bag | Intended Use | Suggested Packing List |
|---|---|---|
| bag 1 | intended use 1 | suggested packing list 1 |
| bag 1 | intended use 2 | suggested packing list 2 |
| . | | |
| . | | |
| . | | |
| bag 1 | intended use N | suggested packing list N |
| bag 2 | intended use 1a | suggested packing list 1a |
| bag 2 | intended use 2a | suggested packing list 2a |
| . | | |
| . | | |
| . | | |
| Bag 2 | intended use Na | suggested packing list Na |
| . | | |
| . | | |
| . | | |
| Bag N | intended use NN | suggested packing list NN |

The system detects whether the user selects a suggested packing list (step 84), such as via the user's selection of an intended use in pull-down menu 143. If the user selects such a list corresponding with a particular intended use (step 86), the system displays in section 130 the suggested packing list for the corresponding intended use of bag 140 by displaying a new set of icons or other indications for the items in the suggested packing list (step 190).

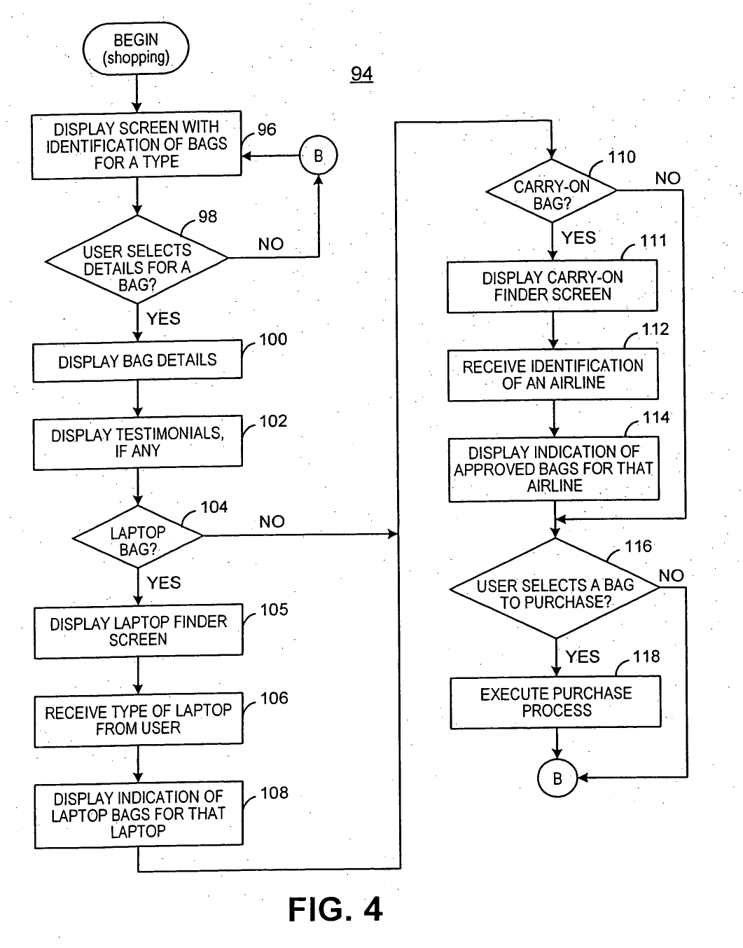

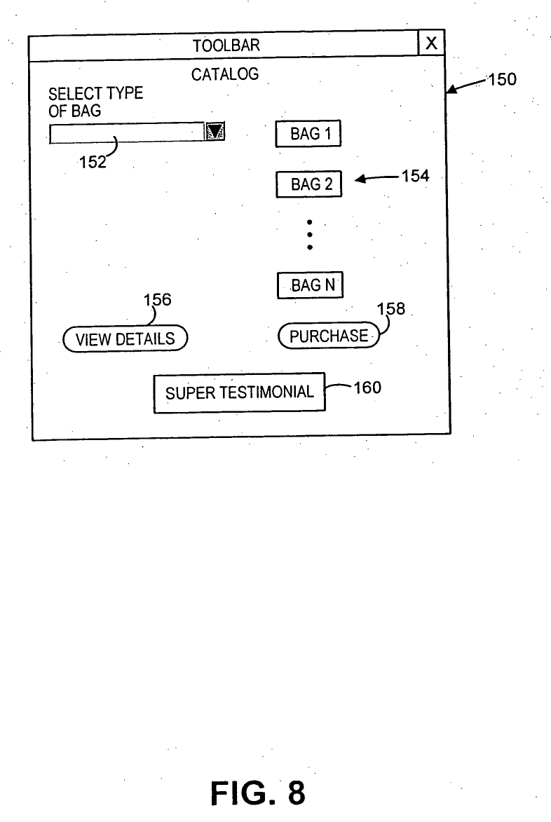

FIG. 4 is a flow chart of a shopping method 94 for use in executing the shopping routine in step 54. Method 94 can be implemented in, for example, software modules for execution by server 36. FIG. 8 is a diagram of an exemplary catalog screen 150 for on-line shopping for bags. Screen 150 can include a pull-down menu 152 for a user to select a type of bag and a section 154 identifying bags corresponding with the selected type. The user can select a section 156 to view details of a selected one of the bags, select a section 158 to add a selected bag to an on-line shopping cart for purchase, or select a section 160 to enter a super testimonial for a selected bag, described below.

In method 94, displays screen 150 with identification of bags for a particular type (step 96). The system can include a database that correlates bags with types and the details for each bag, as illustrated in Table 4. Details for bags can include any particular information further describing or relating to a bag such as size, colors, material, price, and delivery information.

TABLE 4

| Type | Bag | Details |
|---|---|---|
| type 1 | bag 1 | details 1 |
| | bag 2 | details 2 |
| | . | |
| | . | |
| | . | |
| | bag N | details N |
| type 2 | bag 1a | details 1a |
| | bag 2a | details 2a |
| | . | |
| | . | |
| | . | |
| | bag Na | details Na |
| . | | |
| . | | |
| . | | |
| type N | bag NN | details NN |

The system detects whether the user selects section 156 to view details for a particular bag (step 98) and, if so, may it displays the bag details (step 100) along with any testimonials for it (step 102).

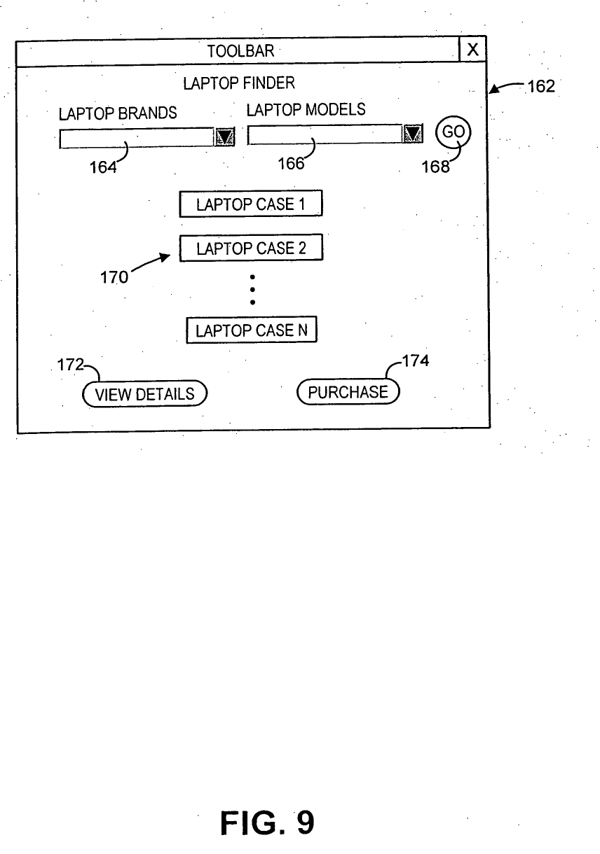

For example, the system may detect whether the user selected laptop bags as a type of bag (step 104). If the user selected laptop bags, the system displays a laptop finder screen 162 shown in FIG. 9. The system receives identification of a type of laptop from the user (step 106) and displays an indication of laptop bags in which that particular laptop will fit (step 108). For example, in screen 162, a user can select a laptop brand and model in sections 164 and 166, respectively, and then select a section 168 to view laptop bags for the identified laptop, as shown by listing 170 of laptop cases. The user can select a section 172 to view details for a selected one of the laptop bags or select a section 174 to add a selected laptop bag to an on-line shopping cart for purchase.

The system can include a database that correlates laptop brands and models with laptop bags in which the corresponding laptops will fit, as illustrated in Table 5.

TABLE 5

| Laptop Brand and Model | Laptop Cases |
|---|---|
| laptop brand 1, model 1 | laptop cases 1 . . . Na |
| laptop brand 1, model 2 | laptop cases 1a . . . Na |
| . | |
| . | |
| . | |
| laptop brand N, model 1 | laptop cases 1N . . . NN |

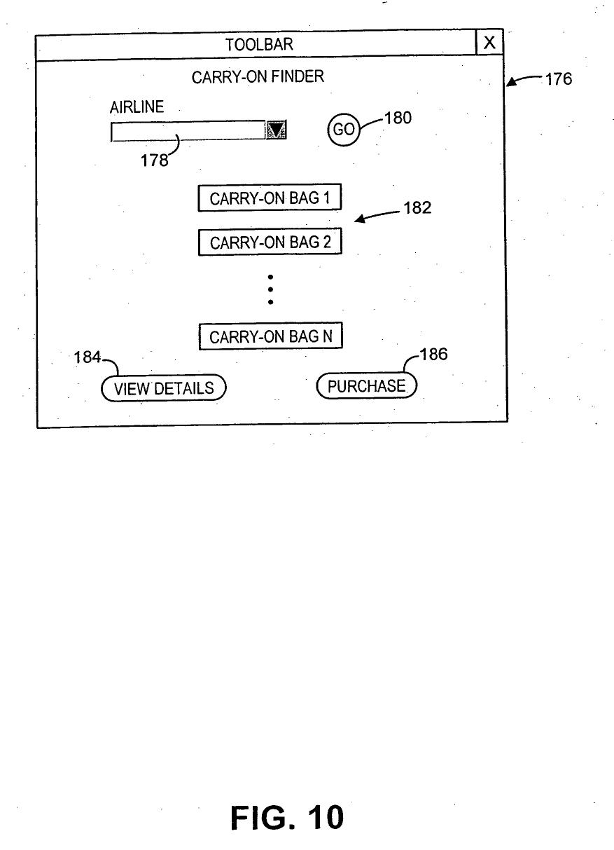

As a further example, the system determines if the user selected airline carry-on bags as a type of bag (step 110). If the user selected carry-on bags, the system displays carry-on finder screen 176 shown in FIG. 10. The system receives identification of a particular airline (step 112) and displays an indication of approved carry-on bags for that airline (step 114). For example, screen 176 includes a section 178 for a user to identify an airline and a section 180 for the user to request approved carry-on bags for that airline, as shown in listing 182. The user can select a section 184 to view details for a selected one of the carry-on bags or select a section 186 to add a selected carry-on bag to an on-line shopping cart for purchase.

In screens 150, 162 and 176, sections 152, 164, 166 and 178 can be implemented with, for example, pull-down menus listing the corresponding information for selection by a user.

The system may further include a database that correlates airlines with approved carry-on bags for them, as illustrated in Table 6.

TABLE 6

| Airline | Approved Carry-On bags |
|---|---|
| airline 1 | carry-on bags 1 . . . N |
| airline 2 | carry-on bags 1a . . . Na |
| . | |
| . | |
| . | |
| airline N | carry-on bags 1N . . . NN |

The system may further detect whether a user had selected one or more bags for purchase (step 116) and, if so, it executes a purchases process for the one or more bags (step 118). On-line processes to obtain user information and credit card information to execute a product purchase and provide for delivery of the product are known in the art.

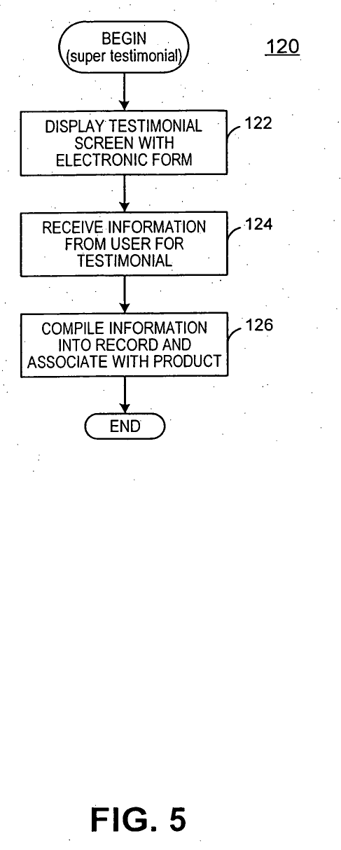

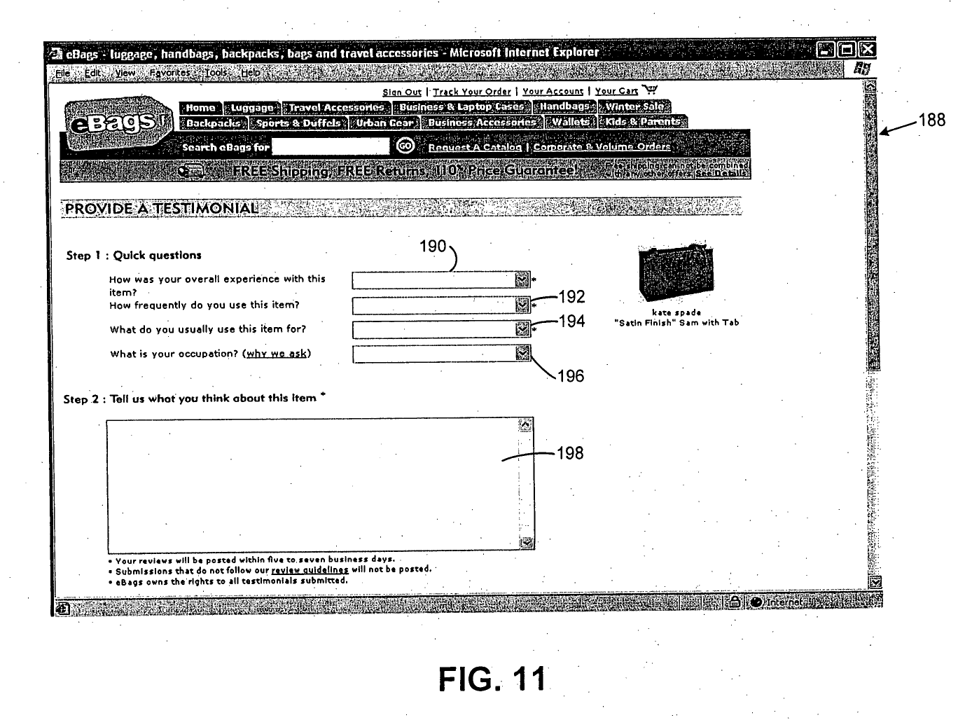

In another aspect of the present invention, FIG. 5 is a flow chart of a super testimonial method 120 for use in executing the super testimonial routine identified in step 58. Method 120 can be implemented in, for example, software modules for execution by server 36. In method 120, the system displays a testimonial form in response to the user's desire to enter a testimonial (step 122), such as via selection of section 160 in screen 150. FIG. 11 is a diagram of a screen 188 for the user to enter a super testimonial. In one example of the screen 188, the user can select options via pull-down menus in a first section. For example, the user can indicate an overall experience with the product in a section 190, a frequency of use of the product in a section 192, a usual use of the product in a section 194, and the user's occupation in a section 196. In a section 198, the user can enter a textual description of his or her opinion of the product and may include a digital photograph of the user with the product in use.

From the electronic form shown in screen 188, the system receives information from the user for the testimonial (step 124), and the system compiles that information into a record or other database structure and associates it with the product (step 126). This information can subsequently be retrieved and used by other potential purchasers when determining whether or not to purchase any particular bag.

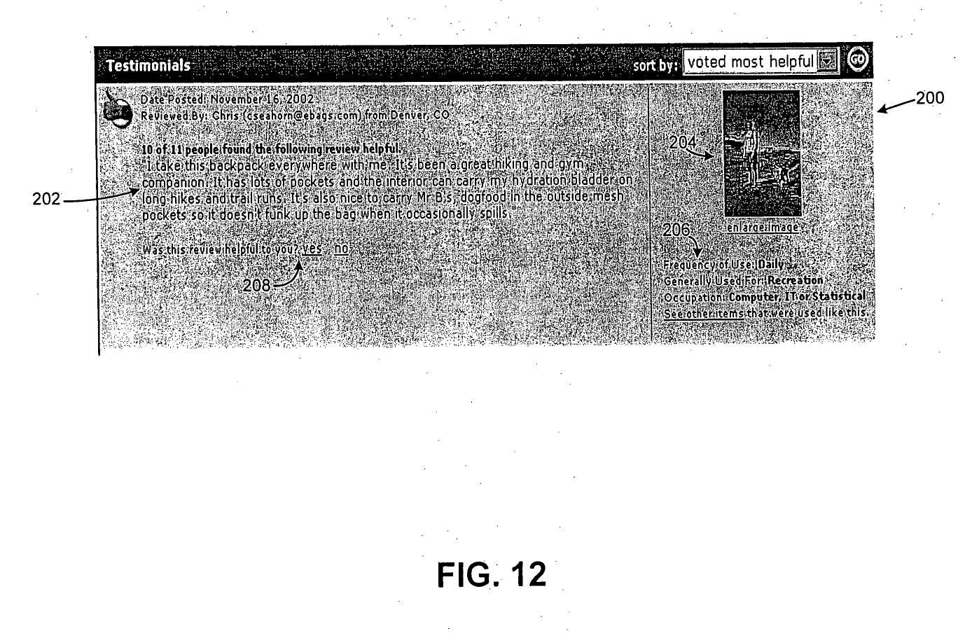

FIG. 12 is a diagram of a screen 200 illustrating an example of a super testimonial for a particular product. In screen 200, the user's information for the testimonial is retrieved and displayed from how it was entered in the electronic form of screen 188. In particular, a section 206 provides the user's answers to the questions in sections 190, 192, 194, and 196 of the form. A section 202 provides the user's textual response from section 198 of the form, and a section 204 may provide a user's image with the product while in use. In section 208, the user viewing the testimonial can provide feedback concerning whether the testimonial was helpful or not to the user.

In order to retrieve testimonials for products, the system can include a database that correlates testimonial information with products so that the system can retrieve and display the information for products, as illustrated in Table 7, including any corresponding photos or images a shown in section 204 of screen 200. This information is then utilized by a prospective customer during a shopping experience.

TABLE 7

| Product | Testimonial Information | Image(s) |
|---|---|---|
| product 1 | testimonial information 1 | image 1 |
| product 2 | testimonial information 2 | image 2 |
| . | | |
| . | | |
| . | | |
| product N | testimonial information N | image N |

Any of the screen described and shown in the present specification can be implemented in, for example, a HyperText Markup Language (HTML) web page or any other particular format for display on the user's machine by a web browser or other program. The screens include various sections, as described above, to provide information or to receive information or commands. The term “section” with respect to screens refers to a particular portion of a screen, possibly including the entire screen. Sections are selected, for example, to enter information or commands or to retrieve information or access other screens. The selection may occur, for example, by using a cursor-control device to “click on” or “double click on” the section. Alternatively, sections may be selected by entering a series of key strokes or in other ways such as through voice commands or use of a touch screen. In addition, although the screens described above illustrate a particular arrangement and number of sections in each screen, other arrangements are possible and different numbers of sections in the screens may be used to accomplish the same or similar functions of displaying information and receiving information or commands. Also, the same section may be used for performing a number of functions, such as both displaying information and receiving a command.

As an illustration of how the testimonial works in practice, the following is provided herein. After a product is purchased, a testimonial is solicited from a customer. The customer is asked to rate the product on several dimensions and write an open-ended review about the product. The customer is also asked a series of demographic and use-based questions about themselves or how they use the product. A sampling of these type of questions and their possible answers are provided herein in the “questions” table. The answers to these questions are then displayed on the website with the testimonial. Visitors to the website may subsequently read the reviews, and view the answers to these questions to gain context for the review and formulate information related to any given product. Visitor may also choose to view other items that were “used like this”. For example, if a piece of carry-on luggage was reviewed by an airline pilot who used the bag daily for work, a visitor reading his/her review would see the following information posted next to the review:
Frequency of Use: Several Times a Week
Generally Used For: Business Travel
Occupation: Airline Pilot

If that visitor chose to view other items that were “used like this”, the search engine would yield a list of similar items that were reviewed by people who answered these questions in the same way, i.e. other bags that are used by airline pilots for business travel several times per week. The results of this search are sorted by relevancy. The general formula for determining search matching and relevancy is described herein:

Formula:

For a product to “match” a particular review that is being searched (the “target” review), it must have been reviewed at least once and the reviewer must have answered at least one of the review questions (see “questions”) the same way as the target review. The more questions that match for a review, the more relevant the match becomes. Each product with matching reviews is scored based on how many reviews it has that are matching and how relevant the matches are, and the results are sorted based upon that score, based on the following formula:
Score=Σ(2^{M}), and where:

M=Total number of matching questions in each review; and the formula is summed for all matching reviews.

One example of questions which may be asked with respect to any given product testimonial are provided herein.

Questions:

| QUESTIONS | ANSWERS |
|---|---|
| How was your overall | Negative |
| experience with this item? | Neutral |
| | Positive |
| How frequently do you | Daily |
| use this item? | Monthly |
| | Several Times a Day |
| | Several Times a Week |
| | Weekly |
| What do you usually | Business Travel |
| use this item for? | Every Wallet/Handbag |
| | Everyday Work |
| | Recreation |
| | School |
| | Special Occasions |
| | Storage |
| | Vacation Travel |
| What is your occupation? | Agriculture |
| | Airline Crew/Support |
| | Airline Pilot |
| | Architecture, Engineering, Science |
| | Business or Financial Operations |
| | Computer, IT or Statistical |
| | Executive/Management |
| | Government/Military |
| | Healthcare |
| | Homemaker |
| | Human Resources |
| | Legal |
| | Marketing/Sales |
| | None |
| | Restaurant or Food Service |
| | Retired |
| | Service or Maintenance Professional |
| | Social and Community Services |
| | Student |
| | Teacher |
| | Tradesman/Craftsman |
| | Transportation (non-airline) |

As appreciated by one skilled in the art, the aforementioned questions are only examples of the type of questions which can be asked, and the invention herein is not limited to these specific questions. Furthermore, the product testimonial can be used for any type of product, and is not limited to the purchasing of bags or luggage, and thus could be used for any type of consumer product.

While the present invention has been described in connection with an exemplary embodiment, it will be understood that many modifications will be readily apparent to those skilled in the art, and this application is intended to cover any adaptations or variations thereof. For example, different labels for the various features, screen sections, and methods, and different types machines and displayed elements on the screens may be used without departing from the scope of the invention. This invention should be limited only by the claims and equivalents thereof.

1. A method for providing an indication of a capacity of a bag, comprising:
receiving a selection of a bag;
displaying indications of a plurality of items;
receiving a selection of a set of the plurality of items; and
determining whether the selected set of said plurality of items will fit within the selected bag and providing an indication of the determination.

2. The method of claim 1, further including displaying an indication of a capacity of the selected bag.

3. The method of claim 1, further including displaying an indication of a remaining capacity of the bag, if the selected set of items will fit within the bag.

4. The method of claim 1, wherein
the receiving the selection of the bag step includes receiving selection of a multi-compartment bag having a plurality of compartments;
the receiving a selection of a set of the items step includes receiving selection of one of the plurality of compartments; and
the determining step includes determining whether the selected set of items will fit within the selected compartment of the multi-compartment bag and providing an indication of the determination.

5. The method of claim 1, further comprising:
receiving an intended use for the bag; and
displaying a suggested packing list of items that correspond with the intended use and will fit within the selected bag.

6. The method of claim 1, wherein the determining step includes making the determination based upon both a size and a shape of each of the selected items in the set.

7. The method of claim 1, further comprising providing an icon which identifies a plurality of bags from which to make a selection.

8. The method of claim 1, further comprising identifying the volume any said plurality of selected items exceeds a given capacity of said bag.

9. A method for providing an indication of a capacity of a bag, comprising:
displaying an indication of a bag;
displaying indications of a plurality of items;
receiving a sequential selection of a set of the item; and
providing upon each selection of an item in the set, an indication as to whether the cumulative selection of items will fit within the bag.

10. The method of claim 9 further including providing, upon each selection of an item in the set, a capacity remaining of the bag and a capacity filled of the bag, if the item will fit within the bag.

11. The method of claim 9, further including providing upon each selection of an item in the set, an exceeded capacity of the bag if the item will not fit within the bag.

12. An apparatus for providing an indication of a capacity of a bag, comprising:
a receive module configured to receive a selection of a bag;
a display module configured to display indications of a plurality of items;
a selection module configured to receive a selection of a set of the items; and
a determine module configured to determine whether the selected set of items will fit within the selected bag and providing an indication of the determination.

13. The apparatus of claim 12, further comprising a module configured to display an indication of a capacity of the selected bag.

14. The apparatus of claim 12, further comprising a module configured to display an indication of a remaining capacity of the bag, if the selected set of items will fit within the bag.

15. The apparatus of claim 12, further comprising a module configuration to display an indication of an exceeded capacity of the bag if the selected items will not fit within the bag.

16. The apparatus of claim 12, wherein:
the receive module includes a module configured to receive selection of a multi-compartment bag having a plurality of compartment;
the selection module includes a module configured to receive selection of one or the plurality of compartments; and
the determine module includes a module configured to determine whether the selected set of items will fit within the selected compartment of the multi-compartment bag and providing an indication of the determination.

17. The apparatus of claim 12, further comprising:
a module configured to receive an intended use for the bag; and
a module configured to display a suggested packing list of items that correspond with the intended use and will fit within the selected bag.

18. The apparatus of claim 12, wherein the determine module includes a module configured to make the determination based upon both a size and a shape of each of the items in the set.

19. The apparatus of claim 12, further comprising a module to display a preferred orientation and arrangement of items to permit said items to fit within the selected bag.

20. An apparatus for providing an indication of a capacity of a bag, comprising:
a display module configured to display an indication of a bag;
an item module configured to display indications of a plurality of items;
a receive module configured to receive a sequential selection of a set of the items; and
a provide module configured to provide, upon each selection of an item in the set, an indication as to whether the cumulative selection of items will fit within the bag.

21. The apparatus of claim 20, further including a module configured to provide, up each selection of an item in the set, a capacity remaining of the bag and a capacity filled of the bag, and an indication if the item will fit within the bag.

22. The apparatus of claim 20, further comprising a data storage module which includes data indicative of the size and volume of said plurality of items and said capacity of the bag.

23. A method for compiling and utilizing information for a product testimonial, comprising:
providing an electronic form having a plurality of questions concerning use of a product for completion by a user;
receiving testimonial information from the user, via the electronic form, relating to the questions concerning the use of the product;
associating the information with the product and when another user browses on-line for potential purchase of the product, displaying the testimonial information associated with the product.

24. The method of claim 23, wherein the receiving testimonial information includes receiving information related to at least one of a user's overall experience with the product, a user's frequency of use of the product, how the user uses the product; and a user's opinion of the product.

25. The method of claim 23 wherein:
the receiving testimonial information step includes receiving an image of the user while using the product; and
the displaying step includes displaying the image along with the testimonial information.

26. The method of claim 23, further including obtaining feedback from the other users concerning whether the testimonial information is helpful to the other users.

27. An apparatus for compiling information for a product testimonial, comprising:
a provide module configured to provide an electronic form having a plurality of questions concerning use of a product for completion by a user;
a receive module configured to receive testimonial information from the user, via the electronic form relating to the questions concerning the use of the product;
a module configured to associate the information with the product; and
a display module configured to, when another user browses on-line for potential purchase of the product, display the testimonial information associated with the product.

28. The apparatus of claim 27 wherein the receive module includes a module configured to receive information related to at least one of a user's overall experience with the product, a user's frequency of use of the product, how the user uses the product, and a user's opinion of the product.

29. The apparatus of claim 27, wherein:
the receive module includes a module configured to receive an image of the user while using the product; and
the display module includes a module configured to display the image along with the testimonial information.

30. The apparatus of claim 27, further including a module configured to obtain feedback from the other user concerning whether the testimonial information is helpful to the other user.

31. A method for providing an indication of a bag suited for carrying a particular laptop computer, comprising:
receiving an identification of a particular laptop computer;
determining one or more bags suited for carrying the particular laptop computer; and
displaying an indication of the one more bags.

32. The method of claim 31, wherein said receiving an identification of a particular laptop computer comprises obtaining information related to the dimensions of said particular laptop computer.

33. The method of claim 31, wherein said determining one or more bags comprises comparing the internal storage capacity of the one or more bags with the dimensions of said particular laptop computer.

34. The method of claim 31, wherein said receiving step comprises a user making a selection on an internet web-site.

35. A method for providing an indication of carry-on bag approved by an airline, comprising:
receiving an identification of a particular airline;
determining one or more carry-on bags approved by the particular airline; and
displaying an indication of the one or more carry-on bags.

36. The method of claim 35, further comprising providing an information storage means which includes data indicative of the overhead storage capacity available for any given plane utilized by the particular airline.

37. The method of claim 35, wherein said displaying an indication of the one or more bags is provided on a computer monitor.

38. The method of claim 35, wherein said determining step comprises comparing an overhead storage capacity for said particular airline with a dimension of said one or more carry-on bags.
